(19) United States
(12) Patent Application Publication
(10) Pub. No.: US 2006/0205560 A1
(43) Pub. Date: Sep. 14, 2006

(54) Transmission unitary shell output carrier and ring gear

(75) Inventor: Thomas Meier, Rochester Hills, MI (US)

Correspondence Address: BROOKS KUSHMAN P.C., 1000 TOWN CENTER, TWENTY-SECOND FLOOR, SOUTHFIELD, MI, 48075, US

(73) Assignee: TransForm Automotive LLC, Sterling Heights, MI (US)

(21) Appl. No.: 11/076,645

(22) Filed: Mar. 10, 2005

(51) Int. Cl. F16H 3/44

(52) U.S. Cl. 475/331

(57) ABSTRACT

A transmission component (12, 12′) for transferring torque about a transmission rotational axis A includes a shell output carrier (62) and a ring gear portion (64) of a unitary one-piece construction flow formed from a blank around a mandrel. The transmission component (12, 12′) transfers torque between a planet gear carrier (28) of a first planetary gear set (18) and a ring gear location of a second planetary gear set (20).

### BACKGROUND OF THE INVENTION

1. Field of the Invention

This invention relates to a torque transmitting component of a transmission for transmitting torque between a planetary gear carrier of a first planetary gear set and a ring gear of a second planetary gear set.

2. Background Art

Transmissions having multiple gear trains for providing different speeds and torque outputs conventionally include multiple planetary gear sets between which torque is transmitted about a rotational axis of the transmission in order to selectively provide the required driving between an input to the transmission and its output. One way in which such torque is transmitted is from a planet gear carrier of a first planetary gear set to a ring gear of a second planetary gear set by an assembly of a shell output carrier and a ring gear that are secured to each other by a snap ring. With such an assembly, the shell output carrier has a generally thin annular wall shape about the transmission rotational axis and has axially spaced first and second ends. The first axial end of the shell output carrier is connected to the planet gear carrier of the first planetary gear set, and the second axial end of the shell output carrier has axially extending teeth that are circumferentially spaced and alternately mated with oppositely facing axially extending teeth of the associated ring gear. A machined groove in the teeth of both the second end of the shell output carrier and the ring gear receive a snap ring that secures the assembly.

Prior art patents noted by an investigation conducted in connection with the invention include U.S. Pat. No. 4,055,976 Kraft; U.S. Pat. No. 4,781,047 Bressan et al.; U.S. Pat. No. 5,384,949 Wodrich et al.; U.S. Pat. No. 5,806,358 Rolf; U.S. Pat. No. 5,927,121 Rolf et al.; U.S. Pat. No. 5,934,126 Maruki et al.; U.S. Pat. No. 6,058,591 Prater; U.S. Pat. No. 6,205,832 Kostermeier; U.S. Pat. No. 6,269,670 Koestermeier; U.S. Pat. No. 6,508,094 Gotou et al.; and U.S. Pat. No. 6,530,253 Gotou et al.

### SUMMARY OF THE INVENTION

An object of the present invention is to provide an improved transmission component for transferring torque about a rotational axis in a transmission between a planet gear carrier of a first planetary gear set and a ring gear of a second planetary gear set.

In carrying the above object, the transmission component of the present invention includes a shell output carrier and a ring gear portion of a unitary one-piece construction flow formed from a blank around a mandrel. The shell output carrier has a generally annular shape of a thin wall construction and includes first and second ends spaced from each other axially along the rotational axis. The first end of the shell output carrier has a connection portion for connecting to a planet gear carrier of a first planetary gear set of the transmission. The ring gear portion has a unitary connection to the second end of the shell output carrier and has internal teeth machined after the flow forming to provide a ring gear for meshing with planet gears of a second planetary gear set of the transmission to thereby transfer torque between the first and second planetary gear sets.

The unitary one-piece construction of the transmission component between the shell output carrier and the ring gear portion ensures torque transmission without any need for tolerance spacings of any connection therebetween like the two-piece construction secured to each other by a snap ring as previously used in the prior art.

In one embodiment, the connection portion of the first end of the shell output carrier includes a plurality of internal teeth that are flow formed and provide connection to the planet gear carrier of the first planetary gear set. These flow formed teeth of the first end of the shell output carrier include a machined retainer groove for receiving a retainer that provides securement of the shell output carrier to the first planetary gear set. After the flow forming, a round hole is punched in the toothed connection portion with its center at the rotational axis.

In another embodiment, the connection portion of the first end of the shell output carrier extends radially inward toward the rotational axis and includes connection holes for providing connection to the planet gear carrier of the first planetary gear set.

Each embodiment of the transmission component has the internal teeth of the ring gear provided with a helical construction. Furthermore, the ring gear portion of each embodiment includes an annular clearance groove that is machined after the flow forming to facilitate the machining of the internal teeth of the ring gear which, as previously stated, preferably have the helical construction.

The machined teeth of the ring gear can be induction heat hardened. It is also possible to carburize the entire unitary one-piece shell output carrier and ring gear with the machined teeth to provide hardening.

The objects, features and advantages of the present invention are readily apparent from the following detailed description of the preferred embodiment when taken in connection with the accompanying drawings.

### BRIEF DESCRIPTION OF THE DRAWINGS

FIG. 1 is a half sectional view of a portion of a transmission which includes a unitary one-piece torque transmitting component constructed in accordance with the present invention.

FIG. 2 is a sectional view taken in the same direction as FIG. 1 but showing only the unitary one-piece transmission component of the invention.

FIGS. 3a, 3b, 3c and 3d show the manner in which the unitary one-piece transmission component is progressively formed from a blank by flow forming and subsequent machining.

FIG. 4 is a half sectional view of a transmission that includes another embodiment of the unitary one-piece transmission component of the invention.

FIG. 5 is a sectional view showing only the transmission component embodiment of FIG. 4 in a manner similar to the first embodiment shown in FIG. 2.

### DETAILED DESCRIPTION OF THE PREFERRED EMBODIMENT

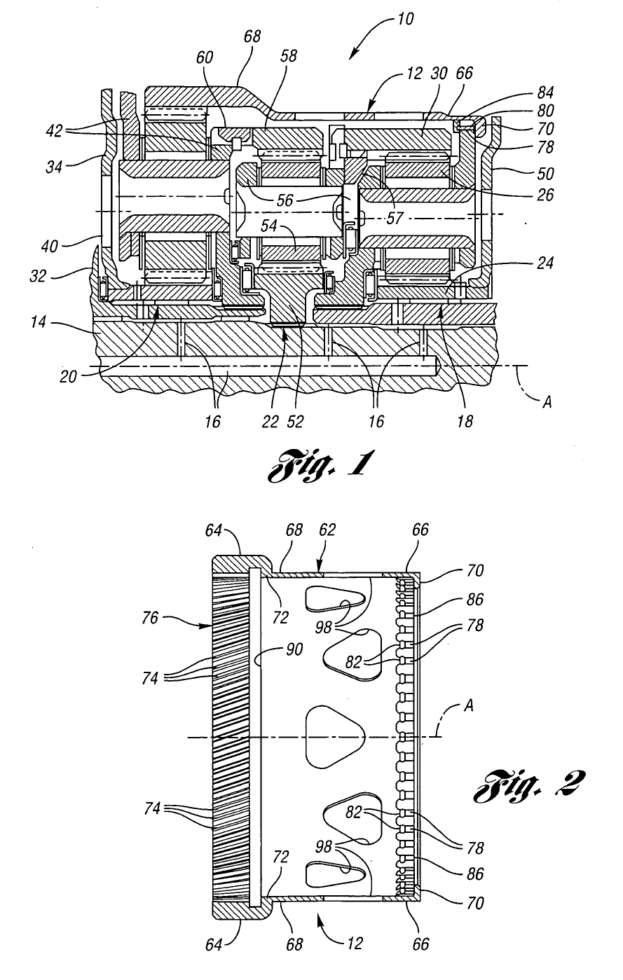

With reference to FIG. 1 of the drawings, a portion of a transmission generally indicated by 10 includes a torque transmitting component 12 that is constructed in accordance with the present invention as is hereinafter more fully described. Transmission 10 includes a central shaft 14 having a central rotational axis A about which components of the transmission rotate and revolve. The central shaft 14 has oil lubrication passages 16 that provide lubricating oil to the transmission during its operation.

With continuing reference to FIG. 1, transmission 10 includes first and second planetary gear sets 18 and 20 that are spaced from each other along the rotational axis A, and the transmission also is disclosed as including a third planetary gear set 22 located axially between the first and second planetary gear sets along the rotation axis A.

The first planetary gear set 18 includes: a sun gear 24, planet gears 26 (normally three, four or five but only one shown) that mesh with the sun gear 24 and are supported for rotation on a planet gear carrier 28, and a ring gear 30 that also meshes with the planet gears 26.

The second planetary gear set 20 includes a sun gear 32 having a connection 34 that is controlled in any suitable manner. Planet gears 40 (normally three, four or five but only one shown) of the second planetary gear set 20 mesh with the sun gear 32 and are rotatably supported by a planet gear carrier 42 whose rotation is controlled in any suitable manner. Likewise, a connection 50 to the sun gear 24 of the first planetary gear set 18 is controlled in any suitable manner.

The third planetary gear set 22 includes a sun gear 52 splined to the central shaft 14 and meshed with planet gears 54 (normally three, four or five but only one shown) rotatably supported on a planet gear carrier 56 having a connection 57 to the ring gear 30 of the first planetary gear set 18. A ring gear 58 of the third planetary gear set 22 has a connection 60 to the planet gear carrier 42 of the second planetary gear set 20.

The transmission component 12 of the present invention as shown in FIG. 2 includes a shell output carrier 62 and a ring gear portion 64 of a unitary one-piece construction flow formed from a blank around a mandrel as is hereinafter more fully described. The shell output carrier 62 has a generally annular shape of a thin wall construction and having its center at the rotational axis A. This shell output carrier includes first and second ends 66 and 68 spaced from each other axially along the rotational axis A. The first end 66 of the shell output carrier 62 has a connection portion 70 for connecting to the planet gear carrier 28 of the first planetary gear set 18 of the transmission. The ring gear portion 64 of the transmission component 12 has a unitary connection 72 to the second end 68 of the shell output carrier 12 and has internal teeth 74 machined after the flow forming to provide a ring gear 76 for meshing with the planet gears 40 of the second planetary gear set 20 to thereby transfer torque between the first and second planetary gear sets.

The unitary one-piece construction of the transmission component 12 provides the torque transfer between the planet gear carrier 28 of the first planetary gear set 18 and the second planetary gear set 20 without any need for connections with tolerances as is the case in the prior art where this component is made as an assembly from multiple pieces.

In the embodiment of FIGS. 1 and 2, the connection portion 70 of the first end 66 of the shell output carrier 62 includes a plurality of internal teeth 78 (FIG. 2) that are flow formed on a mandrel with the rest of the transmission component 12 and are engaged with external teeth 80 of the planet gear carrier 28 of the first planetary gear set as shown in FIG. 1. The flow formed teeth 78 of the first end 66 of the shell output carrier have machined retainer grooves shown in FIG. 2 for receiving a retainer 84 (FIG. 1) to provide securement of the shell output carrier to the first planetary gear set.

As shown in FIG. 2, the transmission component 12 has the connection portion 70 of the first end 66 of the shell output carrier 62 provided with a round hole 86 punched therein after the flow forming so its center is located at the rotational axis A. Punching the hole 86 after the flow forming facilitates the accurate centering of this hole 86 around the rotational axis A.

With reference to FIG. 4, another transmission portion 10′ includes another embodiment of the transmission component 12′ of the present invention. This transmission component 12′ provides connection between the planet gear carrier 28 of the first planetary gear set 18 and the second planetary gear set 20 at its ring gear location in the same manner as the previously described embodiment such that much of the previous description is applicable except as will be noted. As such, like reference numerals are applied to the like portions of this alternate embodiment and the previous description will not be repeated.

Transmission component 12′ shown in FIGS. 4 and 5 has the connection portion 70′ provided with a thin wall construction that extends radially inward toward the rotational axis A and includes connection holes 88 for providing connection to the planet gear carrier 28 of the first planetary gear set. These connection holes 88 are spaced circumferentially about the rotational axis in alignment with the planet gears 26 and receive the shafts 89 of the planet gear carrier to provide the connection of the shell output carrier 62 with the first planetary gear set.

As illustrated in FIGS. 2 and 5, each embodiment of the transmission component 12 and 12′ of the invention has its internal teeth 74 of the ring gear 76 provided with a helical construction to enhance the gear meshing operation with the associated planet gears. Furthermore, the ring gear portion 64 of each embodiment includes an annular clearance groove 90 that is machined after the flow forming to facilitate subsequent machining of the internal ring gear teeth 74 with their helical construction.

Either embodiment of the transmission component 12 or 12′ can be made from SAE 1035 steel with the one-piece construction and the toothed ring gear portion 64 thereof can be induction heated for hardening without induction heating the rest of the component so as to provide cost savings. It is also possible to flow form either embodiment from a chromium alloy such as SAE 5115 steel or SAE 5120 steel and to then carburize the entire component for hardening. Furthermore, it is also possible to utilize SAE 4130 steel of a manganese alloy that can also be carburized to provide hardening. Likewise, there are other material and heat treat possibilities all of which are contemplated by the present invention.

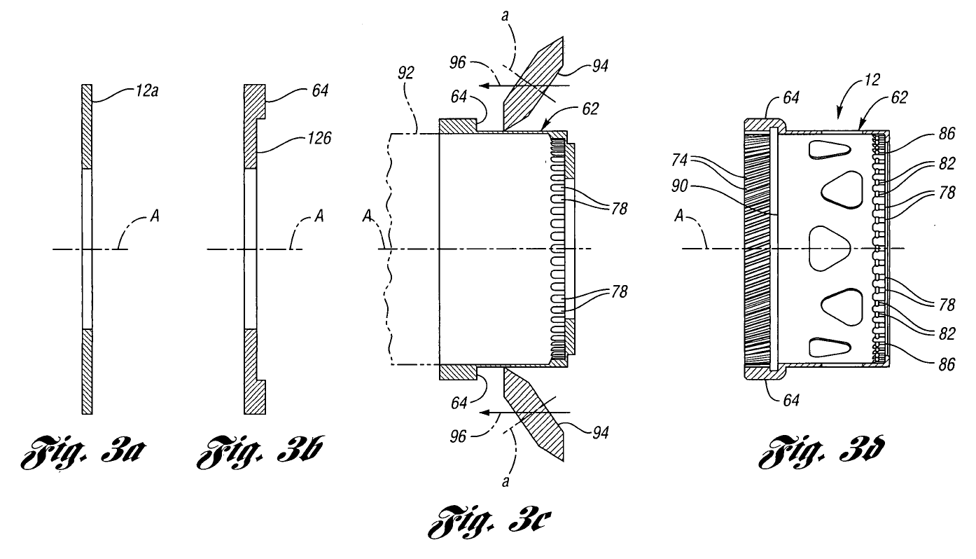

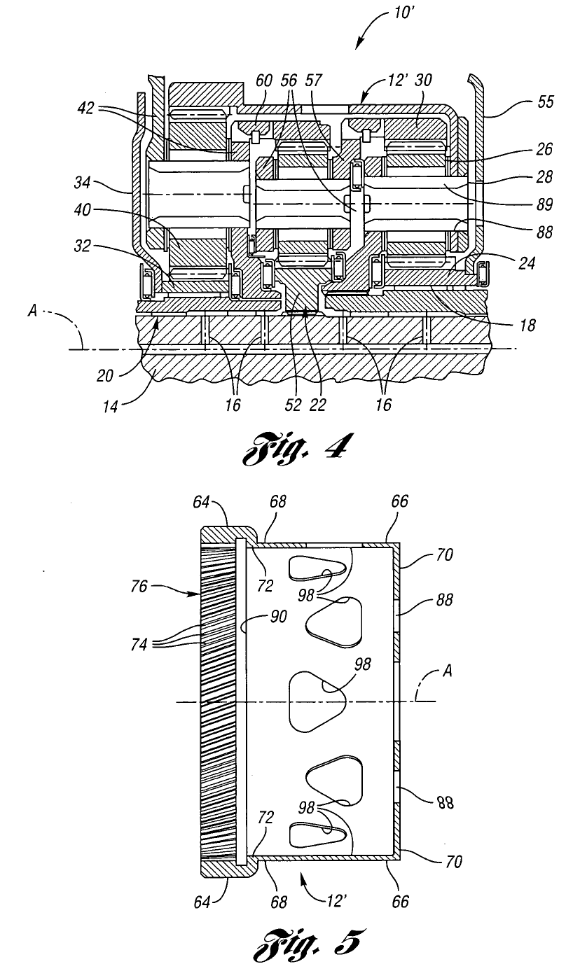

With reference to FIGS. 3a, 3b, 3c and 3d, the flow forming of the one transmission component 12′ is disclosed with the understanding that this flow forming description is also applicable to the other transmission component embodiment 12′ described in connection with FIGS. 4 and 5.

As illustrated in FIG. 3a, the transmission component is formed from a metal blank 12a which may be flat as shown or may actually have a previously stamped or forged shape of the more cup-like construction of the final shape. Flow forming of the flat blank shown initially provides thickening of the ring gear portion 64 as shown in FIG. 3b, but the thickening can also be done by the stamping or forging. Subsequently, the flow forming as shown in FIG. 3c provides the general shape of the transmission component as it is formed about a generally round mandrel 92 that is rotated during the forming about the central rotational axis A. More specifically, roller tools 94 are rotated about associated axes a and move as shown by arrows 96 to provide the flow forming. The mandrel 92 has formations for permitting the flow forming to form the teeth 78 (FIG. 2) that provide the planet gear carrier connection previously described. Normally there are three of the roller tools 94 (FIG. 3a) spaced 120° from each other about the rotational axis although it is also possible to utilize one, two or more than three roller tools. The flow forming provides a unitary one-piece transmission component that is strengthened as compared to a machined component.

After the flow forming, machining as illustrated in FIG. 3d is performed to provide the clearance groove 90 that facilitates machining of the ring gear teeth 74, and the retainer grooves 82 are formed in the teeth 78 as well as the punched hole 86. Openings 98 illustrated in FIGS. 2 and 5 are also formed in the completed transmission components.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A transmission component for transferring torque about a rotational axis in a transmission, comprising:
a shell output carrier and ring gear portion of a unitary one-piece construction flow formed from a blank around a mandrel;
the shell output carrier having a generally annular shape of a thin wall construction and including first and second ends spaced from each other axially along the rotational axis, and the first end of the shell output carrier having a connection portion for connecting to a planet gear carrier of a first planetary gear set of the transmission; and
the ring gear portion having a unitary connection to the second end of the shell output carrier and having internal teeth machined after the flow forming to provide a ring gear for meshing with planet gears of a second planetary gear set of the transmission to thereby transfer torque between the first and second planetary gear sets.

2. A transmission component as in claim 1 wherein the connection portion of the first end of the shell output carrier includes a plurality of internal teeth that are flow formed and provide connection to the planet gear carrier of the first planetary gear set.

3. A transmission component as in claim 2 wherein the flow formed teeth of the first end of the shell output carrier include machined retainer grooves for receiving a retainer that provides securement of the shell output carrier to the first planetary gear set.

4. A transmission component as in claim 3 wherein the toothed connection portion of the first end of the shell output carrier includes a round hole punched therein after the flow forming and located with its center at the rotational axis.

5. A transmission component as in claim 1 wherein the connection portion of the first end of the shell output carrier includes a plurality of internal teeth that are flow formed and provide connection to the planet gear carrier of the first planetary gear set, the flow formed teeth of the first end of the shell output carrier including machined retainer grooves for receiving a retainer that provides securement of the shell output carrier to the first planetary gear set, and the toothed connection portion of the first end of the shell output carrier also including a round hole punched therein after the flow forming and located with its center at the rotational axis.

6. A transmission component as in claim 1 wherein the connection portion of the first end of the shell output carrier extends radially inward toward the rotational axis and includes connection holes for providing connection to the planet gear carrier of the first planetary gear set.

7. A transmission component as in claim 1 wherein the internal teeth of the ring gear have a helical construction.

8. A transmission component as in claim 1 wherein the ring gear portion includes an annular clearance groove that is machined after the flow forming to facilitate machining of the internal teeth of the ring gear.

9. A transmission component as in claim 1 wherein the internal teeth of the ring gear have a helical construction, and the ring gear portion including an annular clearance groove that is machined after the flow forming to facilitate machining of the helical internal teeth of the ring gear.

10. A transmission component as in claim 1 wherein the ring gear with the machined teeth is induction heat hardened.

11. A transmission component as in claim 1 wherein the unitary one-piece shell output carrier and ring gear with the machined teeth are carburized to provide hardening.

12. A transmission component for transferring torque about a rotational axis in a transmission, comprising:
a shell output carrier and ring gear portion of a unitary one-piece construction flow formed from a blank around a mandrel;
the shell output carrier having a generally annular shape of a thin wall construction and including first and second ends spaced from each other axially along the rotational axis, the first end of the shell output carrier having a connection portion including flow formed internal teeth having machined retainer grooves for use in providing connection to a planet gear carrier of a first planetary gear set of the transmission, and the toothed connection portion of the first end of the shell output carrier also including a round hole punched therein after the flow forming and extending with its center at the rotational axis; and
the ring gear portion having a unitary connection to the second end of the shell output carrier and having internal teeth of a helical construction machined after the flow forming to provide a ring gear for meshing with planet gears of a second planetary gear set of the transmission to thereby transfer torque between the first and second planetary gear sets, and the ring gear portion including an annular clearance groove that is machined after the flow forming to facilitate the machining of the helical internal teeth of the ring gear.

13. A transmission component for transferring torque about a rotational axis in a transmission, comprising:
a shell output carrier and ring gear portion of a unitary one-piece construction flow formed from a blank around a mandrel;
the shell output carrier having a generally annular shape of a thin wall construction and including first and second ends spaced from each other axially along the rotational axis, and the first end of the shell output carrier having a connection portion that extends radially inward toward the rotational axis and includes connection holes for providing connection to a planet gear carrier of a first planetary gear set of the transmission; and
the ring gear portion having a unitary connection to the second end of the shell output carrier and having internal teeth of a helical construction machined after the flow forming to provide a ring gear for meshing with planet gears of a second planetary gear set of the transmission to thereby transfer torque between the first and second planetary gear sets, and the ring gear portion including an annular clearance groove that is machined after the flow forming to facilitate the machining of the helical internal teeth of the ring gear.
